(19) United States
(12) Patent Application Publication
(10) Pub. No.: US 2017/0024765 A1
(43) Pub. Date: Jan. 26, 2017

(54) ADAPTIVE USER SUGGESTIONS IN A SOCIAL NETWORKING SERVICE

(71) Applicants: Tzvi Itzhak BARENHOLZ, Raanana (IL); Oded Poncz, Tel Aviv (IL); Ari Leichtberg, Zichron Yaakov (IL); Ori Folger, Tel Aviv - Yafo (IL); Roman Gershman, Rishon Lezion (IL); Eyal Molad, Tel Aviv (IL); Hilly Meerovitch, Kefar Shemaryahu (IL)

(72) Inventors: Tzvi Itzhak BARENHOLZ, Raanana (IL); Oded Poncz, Tel Aviv (IL); Ari Leichtberg, Zichron Yaakov (IL); Ori Folger, Tel Aviv - Yafo (IL); Roman Gershman, Rishon Lezion (IL); Eyal Molad, Tel Aviv (IL); Hilly Meerovitch, Kefar Shemaryahu (IL)

(73) Assignee: GOOGLE INC., Mountain View, CA (US)

(21) Appl. No.: 13/610,748

(22) Filed: Sep. 11, 2012

(51) Int. Cl. G06F 15/16

(52) U.S. Cl. CPC G06Q 30/0255

(57) ABSTRACT

In one aspect, the present disclosure can be embodied in a method that includes providing item recommendations for display to a user of a social networking service based on the user's responses (or lack thereof) to recommendations that were previously displayed or viewed by the user. A score is calculated for each item recommendation based on whether the item recommendation was displayed during a predetermined time period but implicitly rejected by the user. The scores assigned to the respective item recommendations are used to select additional item recommendations for display.

### BACKGROUND

The present disclosure relates generally to recommending related users, and, more particularly, to automatic recommendation of related users of a social networking site.

The advancement of communication services that are publicly available to different users over the Internet or World Wide Web (“web”) has not only allowed such users to share information quickly and easily amongst one another, but also to establish social connections with other users as part of a virtual social network. For example, social networking services may be designed, in part, to store and provide information about the personal or professional social contacts of a user. Such social networking services generally provide the user with a capability to declare different lists or groups for the user's social contacts based on, for example, the type of social connection that the user may have with the members of a particular group. The user may define a list or grouping of social connections corresponding to the user's family members and another list of connections corresponding to various colleagues associated with the user's workplace. In addition, certain social networking services may provide the user with suggestions for adding new social connections based on, for example, the user's existing social connections within one or more publicly available lists or social groups as declared by the user.

### SUMMARY

The disclosed subject matter relates to automatically providing item recommendations to a user of a social networking service based on the user's response to recommendations that were previously displayed or viewed by the user. The item recommendations may be suggestions of new social connections that may be added to a social graph associated with the user in the social networking service. Other applications are possible including, for example, providing recommendations of new web pages, product advertisements, media content, places or other types of entities in the social networking service, based on the user's responses to previously displayed suggestions of such entities. In one innovative aspect, the present disclosure can be embodied in an example method, which includes providing selected item recommendations for display to a user of a social networking service. The user's response with respect to each of the item recommendations displayed during a predetermined time period of user activity in the social networking service is processed. The item recommendations for the user are updated based on the processed response of the user with respect to each of the item recommendations displayed during the predetermined time period. Additional item recommendations may be selected for display to the user based on the updated item recommendations and an amount of time each item recommendation was previously displayed during the predetermined time period relative to a duration of the predetermined time period. Other aspects can be embodied in corresponding systems, apparatus, including computer program products.

These and other embodiments may provide one or more of the following advantages:

(1) enabling the user to provide both explicit feedback (e.g., via a user interface for providing item recommendations) or implicit feedback based on the user's actions with respect to item recommendations that have already been displayed to or viewed by the user using the interface;

(2) providing item recommendations for the user that may be more reflective of the user's actual preferences with respect to social connections or other items of interest (e.g., based on the above-described recommendation profile of the user in the social networking service), rather than recommendations based on attempts to predict such preferences merely using static lists of items associated with the user (e.g., the user's existing or previously declared social connections); and

(3) decreasing the likelihood of item recommendations being ignored by the user or the user becoming disinterested in expanding the user's online social network or using the social networking service in general.

It is understood that other configurations of the subject technology will become readily apparent from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

For purpose of explanation, several features of the subject technology are set forth in the following figures.

FIG. 1 is a diagram of an example network environment suitable for practicing an implementation of the subject technology.

FIG. 2 illustrates an example social graph including the social connections between different users of a social networking service.

FIG. 3 illustrates an example graphical user interface of a client application for providing item recommendations to a user of a social networking service.

FIG. 4 is a process flowchart of an example method for providing item recommendations to a user of a social networking service.

FIG. 5 conceptually illustrates an example electronic system in which some of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced without these specific details.

The disclosed subject matter relates to automatically providing item recommendations to a user of a social networking service based on the user's response to recommendations that were previously displayed or viewed by the user. In an example, the item recommendations are suggestions of new social connections that the user may be interested in adding to the user's existing social network, e.g., as represented in a social graph associated with the user in the social networking service. Suggestions of new social connections for the user may be presented to the user in an interface of the social networking service based on, for example, the user's responses (or lack thereof) to the suggestions that were previously displayed to or viewed by the user via the interface. This may include receiving and processing the user's responses to suggestions that have been displayed via the interface and for which the user did not take any action, for example, by not explicitly rejecting the suggestion via the interface nor adding the suggestion as a new social connection to the user's social network.

In some implementations, the user's responses (or lack thereof) with respect to such suggestions may be processed for a predetermined time period of user activity in the social networking service. The predetermined time period may be based on, for example, a browser cookie file stored (e.g., at the user's device or in a server system associated with the social networking service) for a session of user activity. Further, these processed responses may be used to generate a recommendation profile for the user, which may persist across different sessions of user activity. The recommendation profile may represent, for example, the user's preferences with respect to new item recommendations or user suggestions that the user may be interested in receiving currently or during a relevant time period via the social networking service. Accordingly, the processed (lack of) user responses with respect to previously displayed user suggestions (or other item recommendations) in conjunction with a recommendation profile that persists across various one or more user sessions allows the social networking service to obtain implicit (or negative) feedback from the user automatically, without any user intervention (apart from the user's general use of the functionality of the service). The capability to store persistent data with respect to implicit or negative feedback from the user for each item recommendation enables the social networking service to become aware of the user's preferences for new item recommendations based on the user's interactions with the social networking service during each session of activity. Such session awareness in turn enables the service to refine the persistent recommendation profile for the user in order to identify additional recommendations/suggestions that may be of relatively greater interest to the user during a predetermined or relevant period of time (e.g., one or more user sessions). The additional recommendations/suggestions then may be displayed for the user during subsequent sessions, e.g., via the same or different interface of the social networking service.

The terms “suggestion” and “recommendation” (or “item recommendation”) are used interchangeably herein to refer to a suggestion or recommendation of an item, entity or profile in a social networking service for the same. Although the items and associated lists or sets of recommendations are described in the examples below in the context of social networking and lists of users or user profiles of a social networking service, the subject technology disclosed herein is not intended to be limited thereto. It would be apparent given this description that the subject technology as described herein may be used to provide recommendations for other items in the social networking service. Examples of such other items may include, but are not limited to, web pages, product advertisements, media content, places, things or other types of entities in the social networking service, based on the user's responses to previously displayed suggestions of such items. Furthermore, the techniques as described herein may be applied to different types of entities in other contexts. Examples of other applications of the subject technology to different entities in other contexts may include, but are not limited to, recommendations of additional web pages that may be of interest to users of a web search engine or an online bookmarking service, advertisements of new products that may be of interest to web users for an online advertising service, or recommendations of video or audio files (e.g., movies or songs) to users of a media content distribution service.

Some benefits of the subject technology as described herein relative to conventional solutions may include, for example and without limitation: (1) enabling the user to provide both explicit feedback (e.g., via a user interface for providing item recommendations) or implicit feedback based on the user's actions with respect to item recommendations that have already been displayed to or viewed by the user using the interface; (2) providing item recommendations for the user that may be more reflective of the user's actual preferences with respect to social connections or other items of interest (e.g., based on the above-described recommendation profile of the user in the social networking service), rather than recommendations based on attempts to predict such preferences merely using static lists of items associated with the user (e.g., the user's existing or previously declared social connections); and (3) decreasing the likelihood of item recommendations being ignored by the user or the user becoming disinterested in expanding the user's online social network or using the social networking service in general.

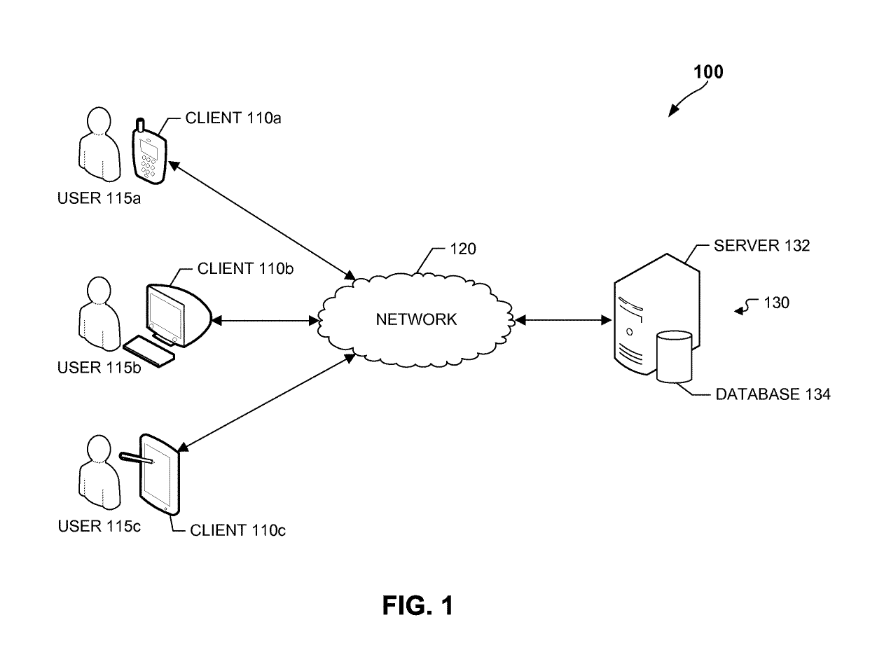

FIG. 1 illustrates an example network environment 100 for implementing techniques to automatically obtain related entities for a given set of initial entities. A network environment 100 includes client devices 110a, 110b and 110c (hereinafter “clients 110a-c”), and a computing system 130. Clients 110a-ccommunicate with one or more servers 132 of computing system 130, for example, through network 120. As shown in FIG. 1, computing system 130 includes at least one server device 132 and at least one computer-readable storage device or database 134. Although only server 132 and database 134 are shown, additional servers and/or databases may be used as may be necessary or desired for a particular implementation. Further, server(s) 132 are communicatively coupled to database(s) 134. Database 134 may store any type of data accessible by server(s) 132. Such data may include, for example and without limitation, data for one or more lists of items or entities. As will be described in further detail below, the stored data may include lists of users organized within a social graph for a social networking service.

Clients 110a-ccan be a general-purpose computer with a processor, local memory, a display, and one or more input devices, e.g., a keyboard or a mouse. Examples of different computing devices that may be used to implement any of clients 110a-cinclude, but are not limited to, a desktop computer, a laptop computer, a handheld computer, a personal digital assistant (PDA), a cellular telephone, a network appliance, a camera, a smart phone, an enhanced general packet radio service (EGPRS) mobile phone, a media player, a navigation device, an email device, a game console, or a combination of any these data processing devices or other data processing devices. Alternatively, each of clients 110a-ccan be a specialized computing device, for example, a mobile handset or tablet computer. Similarly, server 132 can be implemented using any general-purpose computer capable of serving data to any of clients 110a-c. Examples of computing devices that may be used to implement server 132 include, but are not limited to, a web server, an application server, a proxy server, a network server, or a group of computing devices in a server farm.

In some aspects, the computing devices may communicate wirelessly through a communication interface (not shown), which may include digital signal processing circuitry where necessary. The communication interface may provide for communications under various modes or protocols, e.g., Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. For example, the communication may occur through a radio-frequency transceiver (not shown). In addition, short-range communication may occur, e.g., using a Bluetooth, WiFi, or other such transceiver.

In some aspects, network environment 100 can be a distributed client/server system that spans one or more networks, e.g., network 120. Network 120 can be any network or combination of networks that can carry data communication. Such a network can include, but is not limited to, a cellular network, a local area network, medium area network, and/or wide area network, e.g., the Internet, or a combination thereof for communicatively coupling any number of mobile clients, fixed clients, and servers. In some aspects, each of clients 110a-ccan communicate with server 132 via a virtual private network (VPN), Secure Shell (SSH) tunnel, or other secure network connection. In some aspects, network 120 may further include a corporate network (e.g., intranet) and one or more wireless access points.

Server 132 of computing system 130 may be configured to provide users 115a-cwith an interface for a social networking service associated with users 115a-c. As will be described in further detail below, the interface may be accessible to each of users 115a-cfrom a client application executable at client devices 110a-c, respectively. In an example, the interface of the social networking service may be provided through, for example, one or more web pages of a website associated with the social networking service. The web pages may be provided by, for example, server 132 or other web server to clients 110a-cvia network 120. In this example, the client application executable at each of clients 110a-cmay be a web browser and the web pages sent by server 132 may be loaded in the web browser and displayed to users 115a-con a display coupled to clients 110a-c, respectively.

The web pages may include various user interface elements including, but not limited to, user interface elements for interacting with automatic suggestions displayed, for example, in a portion of the interface of the social networking service. For the web interface example, a particular portion of each web page may be dedicated to displaying a list including a predetermined number of suggestions (e.g., three suggestions). The predetermined number of suggestions being displayed may be, for example, a subset of a larger set of suggestions that have been predetermined for the user. One or more lists or sets of suggestions associated with a user may be stored in, for example, one or more remote storage devices communicatively coupled to server 132 via network 120. Further, such lists may be available from a local data store or data repository, e.g., database 134, that is accessible to server 132. The stored lists of suggestions may include, for example, lists that have been compiled from different data sources (e.g., across network 120) and stored in database 134 or other database(s) for processing by server 132.

Different users (or user profiles) may be linked to one another within the social networking service based on, for example, explicitly declared social connections between them. However, it should be noted that the type of social connections between different users identified by server 132 are not limited to explicitly declared connections, and lists of users or other entities may be identified based on implicit relationships between them. For example, implicit relationships may be derived based on the interactions between different entities in association with the same data source (e.g., an interactive portion of a web page). Examples of such user interactions may include, but are not limited to, interactions between different users on a public forum or chat interface hosted at a public web site or interactions between users in a similar forum or chat interface that is provided by the social networking service.

The above-described social connections may be associated with an asymmetric social group declared by a particular user of the social networking service. The social group may be in the form of a social circle including different social connections that are centered around the user. As used herein, a “social circle” may be any collection or set of social connections or contacts for a user. While a social circle can be described from the perspective of an individual user as the center of a particular collection of socially interconnected people, as described above, a social circle also may be described as a set of social connections from the aggregate perspective of a collection of socially interconnected people. A social circle can have narrowly defined boundaries, where all of the members of the social circle may be familiar with one another, and permission may be required for a member to join a social circle.

In an example, each of users 115a-cof client devices 110a-cmay define a social circle as a set or collection of social connections reflecting a particular type of real-world social circle of the user's social network. For example, the user may have different groups of friends, coworkers and family, and there may be some overlap among those groups (e.g., a coworker who is also considered to be a friend, a family member who is also a coworker). Through the creation and use of social circles, the user of a social networking service can organize and categorize social networking contacts into various different groupings. Further, the user may assign certain access rights or user permissions to members of each grouping/circle so as to control the distribution and visibility of the user's personal information and affiliations with respect to the user's individual social connections or contacts within the social networking service. Other examples of social network groups may include a group of users in a computer or mobile phone-based chat session, for example, a short message service (SMS) chat session or an instant messaging (IM) chat session, an individual profile in a social networking service, or a combination of two or more individual profiles in the social networking service.

In addition to the social connections between different users and their respective profile information, as described above, other information that may be associated with the social graph may also include different content items that are associated with each social network group or social circle of each user. Examples of such content items include, but are not limited to, one or more photographs, videos, “checked-in” geographic locations, articles, reviews of geographic points of interest, text, audio or video chat room interfaces, status updates or calendar events. For example, such content items may be added to the information associated with the social network group or circle by one or more of its members. The content items may be provided by each user and stored at, for example, database 134 in association with the respective accounts or profiles of individual users of the social networking service. Alternatively, the content items may be gathered from sources external to the database 134 using, for example, a web crawler. In some implementations, users of the social networking service may opt out of having data about the user gathered from sources external to the social networking service being brought into the social networking service. In a particular implementation, the user may indicate that he/she wishes to opt out of having such data brought into the social networking service by modifying his/her account settings with the social networking service.

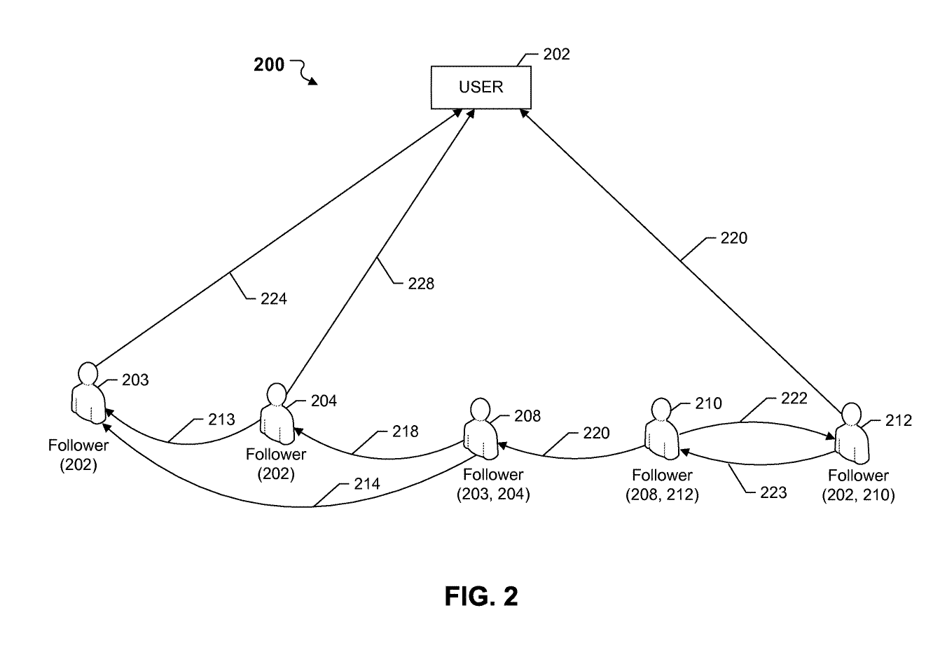

In an example, a user may be considered the creator or “owner” of the social circle for which the user has chosen to follow one or more other users of a social networking service. Likewise, the individual user, who is the owner of the social circle in this example, may also be a member of another social circle owned by one of the members in the user's social group/circle. As the different social circles within the social networking service may be asymmetrically related, this user may not be a member of any of the social circles associated with various other members of the user's social circle. For example, each user may have the ability to follow one or more other users through social connections that are associated with a social networking service or site. As described above, server 132 may use user profile information based on data from a social graph in order to obtain related user profiles. For example, at least a portion of the lists of users of a social networking service, as described above, may be derived based on social connections between different users that may be represented using a social graph, as will be described in further detail below with respect to FIG. 2.

FIG. 2 illustrates an example of a social graph 200 including the social connections between different users of a social networking service. As shown in FIG. 2, the example social graph 200 corresponds to one or more social circles associated with a user 202, and includes various members (users 204, 206, 208, 210 and 212). In an example, the social graph 200 may represent a union of all members of public circles for user 202. For example, social graph 200 may be determined based on user 202's use of a computer-implemented social networking service or web site, as described above. For example, user 202 can generate a profile within the social networking service. Further, user 202 can create a social circle by digitally associating the user's generated profile with the profiles of one or more other users of the social networking service (e.g., users 204, 206, 208, 210 and 212). Also, as described above, user 202 may upload content items via the social networking service to be published in association with the social circle.

As shown by the connections or edges of social graph 200, some of the members of user 202's public circle, i.e., user 204, 206 and 212 are also followers of user 202, as indicated by the edges 226, 228 and 220 (labeled “follower (202)”), respectively. For example, a follower of user 202 may be any other user of the social networking service having a public circle in which user 202 is also a member. Similarly, edges 214 and 216 of social graph 200 indicate that both user 206 and user 208, respectively, are followers of user 204 within the social networking service. Social graph 200 also shows the following connections between the remaining members of the user 202's social circle(s): user 208 is a follower of user 206, as indicated by edge 218; user 210 is a follower of both user 208 and user 212, as indicated by edges 220 and 222, respectively; and user 212 is a follower of user 210, as indicated by edge 224. In the example social graph 200 shown in FIG. 2, user 210 is not a follower of user 202 within the social networking service. Instead, user 210 may be another user of the social networking service that has limited access to the information and/or posts provided by user 202. As for user 212, however, in addition to following user 202 as noted above, user 212 is also following user 210, as indicated by edge 222. However, user 212 is not following users 204, user 206 or user 208.

For example, user 202 may have previously granted permission allowing user 204 and user 206 to follow user 202 and add the appropriate social connection to user 202 in the social networking service. This enables any public information and/or data items provided by user 202 to be shared with user 204 and user 206. In some aspects, user 202 is able to establish a privacy setting for each content or data item associated with the user 202's profile such that only certain members of user 202's public circles, or a subset of contacts of user 202 within the social networking service, are able to view and interact with such item. Likewise, other users in social graph 200 may have granted prior approval for similar social connections to their followers. The prior approval granted by each user may have been, for example, in the form of a response to an automated notification indicating a request to be followed by another user or added to the other user's social circle. The automated notification may be sent to the respective user's computing device via, for example, an interface provided for the social networking service at the user's device.

However, it should be noted that such explicit permission may not be required for establishing social connections or sharing information between different users. For example, user 204 may include user 202 in a social circle created and customized by user 204, which allows information sharing between the users without any explicit permission from user 202. Further, it should be noted that any type of sharing model for users associated with a social networking site or service may be used and that the subject technology as described herein is not intended to be limited to any one particular implementation.

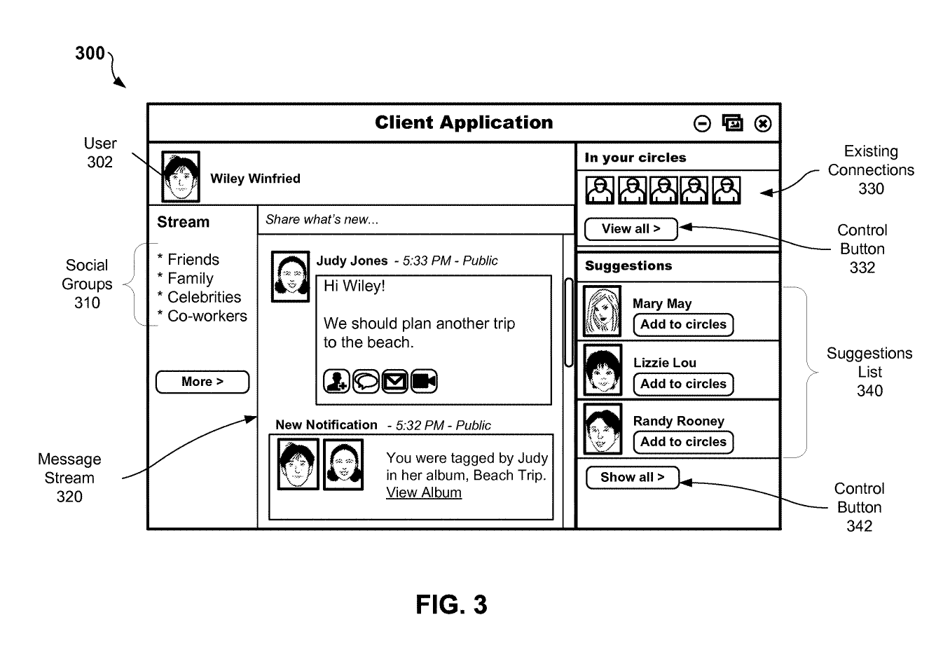

Referring back to FIG. 1, server 132 may include logic that processes lists of related user profiles and transmits the processed lists to clients 110a-cover network 120. For example, server 132 may order items in a list and possibly format the list for presentation to any of clients 110a-c. The items in each list may correspond to, for example, profiles of different users of the social networking service. Clients 110a-cmay then present the related entities as automatic suggestions of new social connections that may be of interest to users 115a-c. The automatic suggestions may be displayed at clients 110a-c, for example, as a selectable list of entities or user profiles. Such a selectable list may be presented to the user via, e.g., a graphical user interface (GUI) displayed at the device, as will be described in further detail below with respect to FIG. 3.

FIG. 3 illustrates an example GUI 300 that may be displayed as part of a client application executable at a computing device (e.g., any of client devices 110a-cof FIG. 1, as described above) of a user 302. Such a client application may be a specialized application program integrated with the social networking service or a general purpose application, for example, a web browser executable at the user's 302 device, as described above. As such, GUI 300 may be provided by a web server (e.g., server 132 of FIG. 1, as described above) over a network (e.g., network 120) in the form of one or more web pages loaded in the web browser and displayed to the user via a content area of the web browser. The web page(s) may include various user interface elements enabling user 302 to access the different functionality offered by the social networking service or website. Such functionality may be part of, for example, a new user sign-up process flow or merely associated with general use of the social networking service.

As shown by the particular example of FIG. 3, the social networking service or site may include a chat interface or message stream 320 enabling user 302 to send and receive messages as well as other content items (e.g., images or other media files) to and from other users or subscribers of the social networking service. Such other users may be, for example, members of the different social groups 310 associated with the user in the social networking service, as described above. In addition to displaying a list of existing social connections 330 of user 302, GUI 300 also displays a suggestions list 340 including suggestions of new social connections for user 302. As noted previously, while GUI 300 is described in the context of such new user suggestions, the techniques described herein are not intended to be limited thereto. In some implementations, GUI 300 may be configured to display recommendations for other types of items that may be of interest to user 302 based on, for example, explicit or implicit feedback or input from user 302 regarding similar item recommendations previously displayed to user 302 via GUI 300 or another interface of the social networking service. Also, as noted previously, examples of other types of recommended items may include, but are not limited to, web pages, product advertisements, media content, places, things or other types of entities in the social networking service, based on the user's responses to previously displayed recommendations of such items.

Due to the limited size of the respective portions of GUI 300 in which to display the list of existing connections 330 and the new user suggestions list 340, the items displayed for each list may be limited to a predetermined number, e.g., based on the size of the display area. However, as shown in FIG. 3, GUI 300 may include control buttons 332 and 342 for enabling the user to expand each list and view additional connections in the user's 302 existing social graph or new user suggestions that may be added, respectively, that may extend beyond the viewable portions of GUI 300 in which the list of connections 330 and suggestions list 340 are displayed. The additional social connections or new suggestions that are available for user 302 may be displayed in a separate content area or new window (e.g., in a pop-up window) of GUI 300.

As described above, the suggestions displayed in this portion of GUI 300 may be selected from a larger predetermined list of suggestions associated with the user. The larger predetermined list of suggestions may be based on, for example, the user's existing social contacts or connections 330 within one or more lists or social graphs associated with the user, as noted above. These social contacts or connections may include, for example, members of at least one of the social groups 310 associated with the user and identified by the social networking service. Each of the social groups 310 may have been declared by user 302 or another user of the social networking service, e.g., who may have added user 302 to the group via the social networking service.

The predetermined number of suggestions within the larger or primary list or set of suggestions, from which suggestions are selected to be displayed in suggestions list 340, may be limited so as to represent a list of only the most relevant suggestions (e.g., top 15 suggestions). As will be described in further detail below, the relevance of a suggestion may be based on, for example, a threshold probability indicating a likelihood of a suggestion being related to the user's existing social connections 330 and therefore, being a suggestion for which the user 302 may have an interest in adding as a new social connection to the user's existing social graph.

Referring back to the example computing system 130 of FIG. 1, server 132 may be configured to process a response (or a lack thereof) from user 302 with respect to each of the displayed item recommendations during a predetermined time period of user activity. Such a user response may include, for example and without limitation, user input either accepting or explicitly rejecting an item recommendation that has been displayed (e.g., via the interface of the social networking service) during the predetermined time period. Alternatively, the response may include no user input with respect to the displayed item recommendation.

In some implementations, the suggestions that have been displayed to user 302 may be tracked by server 132 for one or more sessions of use of the social networking service. An individual session of use may correspond to, for example, a predetermined period of time during which user 302 accesses various functionality of the social networking service via GUI 300 or another interface of the social networking service in which the suggestions are displayed. Using the above-described example of GUI 300 as a web interface, a session may be tracked using a browser cookie file associated with the session, as described previously. In some implementations, the predetermined period of time may correspond to, for example, an expiration time defined in individual session cookies, after which a new session begins and a new or updated session cookie may be generated and stored (e.g., at the user's device). As will be described in further detail below, the subject technology described herein may help to ensure that the user does not view the same suggestion that was previously ignored during the same session multiple times.

In some implementations, the social networking service may maintain a session log including a record of suggestions that were displayed to the user and for which the user did not take any action. The session log may be, for example, a temporary file stored at database 134 of computing system 130 of FIG. 1 or other server system of the social networking service for recording suggestions displayed during a single session. Alternatively, one or more session logs may be stored for an extended period of time in association with other profile or account information for the user in the social networking service. As such, the session log may include previously displayed suggestions that have been accumulated during one session or over multiple sessions. The accumulated suggestions may represent, for example, a subset of the larger predetermined list of suggestions described above.

Server 132 may use the data related to user responses for previously displayed suggestions from the session log(s) (e.g., stored in database 134) as a parameter for calculating a score or conditional probability value representing a relative strength or weakness of a suggestion with respect to its determined degree of relation or relevance to the user's existing set of social connections 330. In some implementations, server 132 may use, for example, a prediction or ranking algorithm for assigning a relative score to each item or user suggestion in a predetermined set of suggestions/recommendations. The existing social connections of may be defined in a social graph (e.g., social graph 200 of FIG. 2, as described above) associated with the user 302. Further, the larger or primary predetermined list of suggestions may be updated periodically, for example, as new social connections are formed or other changes made to a social graph associated with user 302 over time. The social graph and predetermined list of suggestions may be stored in database 134, as described above. In an example, server 132 may use the ranking algorithm to calculate a score for each of these accumulated based on the number of times that suggestion was displayed and not acted upon by (or no input was received from) the user. Such suggestions may be treated as being implicitly rejected by the user. As noted above, the calculated score may be determined for such implicitly rejected suggestions over a predetermined period of time corresponding to an individual session or multiple sessions.

In some implementations, the ranking algorithm may be used to assign different weights to each score so as to apply a relatively greater penalty (e.g., by decreasing the assigned score) for suggestions or item recommendations that have been displayed a relatively greater number of times during the same time period or the same number of times during a relatively shorter period of time. The penalty may be, for example, proportional to the number of times the suggestion/item recommendation has been displayed during a predetermined time period. In an example, a suggestion that has been displayed to the user a certain number of times (e.g., between 1 and 10 times) within a relatively short period of time (e.g., within the most recent two weeks) may be assigned a greater penalty (e.g., between a ±40% to ±60% penalty) than a different suggestion that has been displayed the same number of times within a longer time period (e.g., more than two weeks or over 1-2 months ago). For example, the second suggestion may be assigned a relatively smaller penalty (e.g., between a ±10% to ±30% penalty). In this way, the social networking service is able to apply adaptive weights to each item recommendation's score, which may be adjusted dynamically in proportion to the number of times each recommendation has been displayed during the predetermined time period and the duration or length of the time period. Further, this allows the social networking service to discern whether the user actually ignored the item recommendation in the context of using the functionality of the social networking service or merely did not see the recommendation during a period of inactivity. Such a period of inactivity may include, for example, an extended period during which the user was not actively using the functionality or features of the social networking service (e.g., by not logging into a personal user account associated with the user's stored profile in the social networking service).

Server 132 or the ranking algorithm may use any one of various techniques to calculate the score or penalty for those suggestions that have been implicitly rejected by the user (or “implicit rejections”), as described above. For example, each implicit rejection may be assigned a baseline score, which gets discounted during or after each session based on the number of times the suggestion has been displayed and the amount of time that has elapsed since the suggestion was displayed to the user previously. Further, the assigned score may be discounted multiple times across multiple sessions. In addition, the discounted score may persist with the suggestion on a permanent basis or alternatively, may dissipate or reset (e.g., back to the initial baseline value) after a predetermined period of time has elapsed.

In some implementations, the implicitly rejected suggestions may be grouped into different classes or categories of suggestions, where the scores (or penalties) for an implicit rejection may be weighted based on the particular category of suggestion to which it belongs. Thus, the score of a given suggestion may be determined based in part on the score or penalty assigned to one or more implicit rejections of suggestions that may be similar or of the same category. The categories of implicitly rejected suggestions may be based on, for example, a degree of similarity or relation between different suggestions (or the new/suggested user or social connection to which each suggestion corresponds). This may be based on, for example, the relation or degree of separation between different nodes in a social graph associated with the user, where the nodes may represent other users. Such other users also may be members of the social networking service. Additionally, such users may be members of a social group or existing social connection associated with the user in the social networking service. Further, the degree of relation or separation between different suggestions/users within the social networking service may be based on various characteristics of each suggestion. Examples of such characteristics may include, but are not limited to, the relative popularity of each suggestion, membership in a particular social group or list associated with the user (e.g., suggestions based on a list of the user's email contacts), user profile information corresponding to the new/suggested social connection and whether the new/suggested social connection is also a registered user of the social networking service.

As previously described, the social networking service may use the scores assigned to the implicitly rejected item recommendations (e.g., suggestions of new user profiles or social connections) to generate a recommendation profile for the user (e.g., user 302) that persist over multiple user sessions. In this way, the social networking service can automatically obtain implicit feedback from the user during each session of use to further improve or refine the awareness of the user's actual preferences or current interests with respect to item recommendations or suggestions for new social connections within the social networking service. Further, additional recommendations/suggestions that may be more reflective of the user's actual preferences or interests may be identified and provided to the user during subsequent sessions, e.g., via the same or different interface of the social networking service.

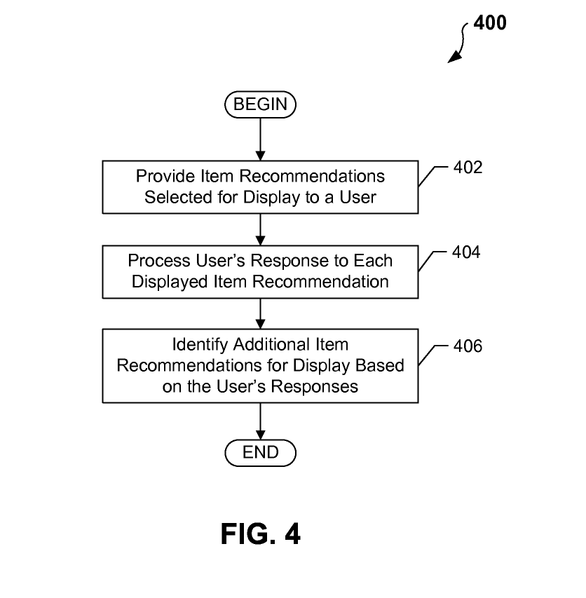

FIG. 4 is a flowchart of an example method 400 for providing item recommendations to a user of a social networking service based on the user's responses to previously displayed recommendations. For purposes of discussion, method 400 will be described using network environment 100 of FIG. 1, as described above, but method 400 is not intended to be limited thereto. Thus, the steps 402, 404 and 406 of method 400 may be performed by, for example, computing system 130 of FIG. 1, as described above. Further, for ease of explanation, method 400 will be described using GUI 300 of FIG. 3, as described above. However, it should be noted that method 400 is not intended to be limited thereto.

Method 400 begins in step 402, in which item recommendations are provided to a user (e.g., user 302 of FIG. 3, as described above) of a social networking service. The item recommendations may be selected from a predetermined set of item recommendations, as described above. Further, the recommendations may be provided via, for example, an interface of the social networking service. The interface may be, for example and without limitation, a graphical user interface (e.g., GUI 300 of FIG. 3, as described above) of the social networking service that is displayed within a client application executable at the user's device, as described above. Further, a portion of the interface may be used to display item recommendations selected from a predetermined set of item recommendations for the user. Each item may be, for example, a different user, place or thing in the social networking service. In an example, as described above, the recommended items may be suggested profiles of other users of the social networking service, which the user may be interested in adding as a new social connection to the user's existing social graph in the social networking service. Also, as described above, examples of other types of items that may be recommended to the user via the interface may include, but are not limited to, web pages, product advertisements, media content, places, things or other types of entities in the social networking service.

Step 404 includes processing the user's responses (or lack thereof) with respect to each displayed item recommendation. The processed responses may then be used to identify the previously displayed item recommendations for which the user implicitly rejected, as described above. Such implicit rejections may be identified based on, for example, a determination (e.g., by server 132 of FIG. 1, as described above) that no input was received from the user during a predetermined time period of user activity in the social networking service. The predetermined time period may correspond to one or more sessions of use of an interface of the social networking service, a portion of which may be used for displaying the item recommendations. As described above, the item recommendations being displayed may be from a predetermined set of item recommendations. In an example, the predetermined set of item recommendations may include new user suggestions based on, for example, the user's existing social contacts or connections within one or more lists or social graphs associated with the user, as noted above. These social contacts or connections may include, for example, members of a social group associated with the user and identified by the social networking service. The social group may have been declared by the user or another user.

In some implementations, step 404 may include assigning a score to each of the item recommendations in the set based on the identification. The assigned score also may be adjusted so as to give relatively less weight to the identified item recommendations. In some implementations, a prediction or ranking algorithm may be used to calculate the score (e.g., conditional probability value) being assigned, which may represent, for example, a relative strength or weakness of a particular item recommendation. The relative strength or weakness of an item recommendation may be reflective of, for example, its degree of relation or relevance to the known preferences or existing set of social connections (e.g., as defined in a social graph) associated with the user in the social networking service. Information related to such user preferences or social connections may be stored, for example, in association with a profile of the user in the social networking service.

In step 406, additional item recommendations are identified for display to the user based on the responses of the user processed in step 404. Thus, the calculated scores assigned to each item recommendation in the predetermined set of item recommendations for the user, as described above may then be used in step 406 to select new item recommendations for display in the interface. Accordingly, item recommendations having relatively greater scores may be given higher priority and thus, selected for display before item recommendations having relatively lesser scores (or relatively lower priority). Different weights also may be assigned to each score so as to apply a relatively greater penalty (e.g., by decreasing the assigned score) for item recommendations that have been displayed a relatively greater number of times during the same time period. Similarly, a relatively greater penalty may be applied to scores of item recommendations that have been displayed an equal number of times during a relatively shorter period of time. As such, the penalty applied to each score may be, for example, proportional to the number of times the suggestion has been displayed during a predetermined time period, as described above. Further, the assigned score may be discounted multiple times across multiple sessions. In addition, the discounted score may persist with the suggestion on a permanent basis or alternatively, may dissipate or reset (e.g., back to the initial baseline value) after a predetermined period of time has elapsed. Thus, in contrast with conventional solutions, method 400 enables the social networking service to provide suggestions that may be more reflective of actual user behavior or preferences with respect to the social connections of interest within the social networking service.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

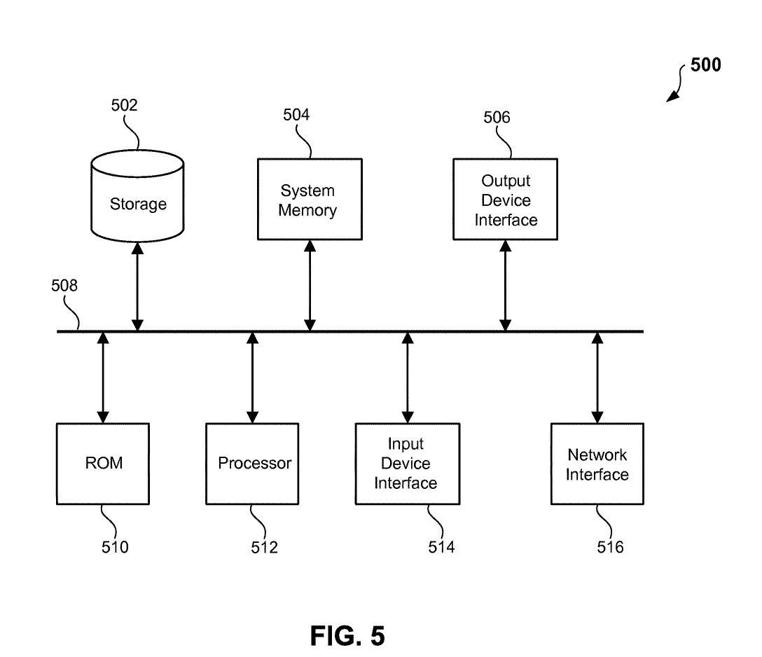

FIG. 5 conceptually illustrates an example electronic system with which some implementations of the subject technology are implemented. Electronic system 500 can be a computer, phone, PDA, or any other sort of electronic device. For example, each of client devices 115a-cor computing system 130 of FIG. 1, as described above, may be implemented using electronic system 500. As shown in FIG. 5, electronic system 500 includes various types of computer readable media and interfaces for various other types of computer readable media. Electronic system 500 includes a bus 508, processing unit(s) 512, a system memory 504, a read-only memory (ROM) 510, a permanent storage device 502, an input device interface 514, an output device interface 506, and a network interface 516.

Bus 508 collectively represents all system, peripheral, and chipset buses that communicatively connect the numerous internal devices of electronic system 500. For instance, bus 508 communicatively connects processing unit(s) 512 with ROM 510, system memory 504, and permanent storage device 502.

From these various memory units, processing unit(s) 512 retrieves instructions to execute and data to process in order to execute the processes of the subject disclosure. The processing unit(s) can be a single processor or a multi-core processor in different implementations.

ROM 510 stores static data and instructions that are needed by processing unit(s) 512 and other modules of the electronic system. Permanent storage device 502, on the other hand, is a read-and-write memory device. This device is a non-volatile memory unit that stores instructions and data even when electronic system 500 is off. Some implementations of the subject disclosure use a mass-storage device (such as a magnetic or optical disk and its corresponding disk drive) as permanent storage device 502.

Other implementations use a removable storage device (e.g., a floppy disk, flash drive or disk drive) as permanent storage device 502. Like permanent storage device 502, system memory 504 is a read-and-write memory device. However, unlike storage device 502, system memory 504 is a volatile read-and-write memory, such a random access memory. System memory 504 stores some of the instructions and data that the processor needs at runtime. In some implementations, the processes of the subject disclosure are stored in system memory 504, permanent storage device 502, and/or ROM 510. For example, the various memory units include instructions for automatically performing the steps of method 400 of FIG. 4, as described above, in accordance with an implementation of the subject technology disclosed herein. From these various memory units, processing unit(s) 512 retrieves instructions to execute and data to process in order to execute the processes of some implementations.

Bus 508 also connects to input and output device interfaces 514 and 506. Input device interface 514 enables the user to communicate information and select commands to the electronic system. Input devices used with input device interface 514 include, for example, alphanumeric keyboards and pointing devices (also called “cursor control devices”). Output device interfaces 506 enables, for example, the display of images generated by the electronic system 500. Output devices used with output device interface 506 include, for example, printers and display devices, e.g., cathode ray tubes (CRT) or liquid crystal displays (LCD). Some implementations include devices, e.g., a touch-screen that functions as both input and output devices.

Further, as shown in FIG. 5, bus 508 also couples electronic system 500 to a network (not shown) through a network interface 516. In this manner, the computer can be a part of a network of computers (such as a local area network (“LAN”), a wide area network (“WAN”), or an Intranet, or a network of networks, e.g., the Internet. Any or all components of electronic system 500 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, e.g., microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, e.g., is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, e.g., application specific integrated circuits (ASICs) or field programmable gate arrays (FPGAs). In some implementations, such integrated circuits execute instructions that are stored on the circuit itself.

As used in this specification of this application, the terms “computer”, “server”, “processor”, and “memory” all refer to electronic or other technological devices. These terms exclude people or groups of people. For the purposes of the specification, the terms display or displaying means displaying on an electronic device. As used in this specification of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include multiple clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Any reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

1. A computer-implemented method comprising:
providing selected item recommendations for display to a user via an interface of a social networking service;
processing a response of the user including the user's interactions with respect to each of the item recommendations displayed during at least a portion of a predetermined time period of user activity in the social networking service corresponding to a activity session associated with a first cookie file that defines an expiration time;
categorizing, based on the user's interactions, each of the item recommendations displayed for which no input was received from the user during the predetermined time period as implicitly rejected item recommendations;
grouping the implicitly rejected item recommendations into different categories;
storing information related to the implicitly rejected item recommendations, the information identifying each implicitly rejected item recommendation and an amount of time the implicitly rejected item recommendation was displayed to the user during the predetermined time period;
updating the item recommendations for the user based on the processed response of the user with respect to each of the item recommendations displayed during the predetermined time period;
calculating a score for each of the updated item recommendations for the user so as to apply a penalty to the respective scores of each implicitly rejected item recommendation, wherein the penalty is based in proportion on the amount of time the implicitly rejected item recommendation was displayed relative to a duration of the predetermined time period such that, for a same total amount of time the implicitly rejected item recommendation is displayed, the penalty assessed to the implicitly rejected item recommendation increases as the duration of the predetermined time period decreases, and wherein calculating the score for each of the updated item recommendations is based at least in part on the score of one or more other implicitly rejected item recommendations in the same category as the updated item recommendation;
assigning the calculated score to each of the respective item recommendations; and
selecting additional item recommendations for display to the user during a subsequent activity session associated with a second cookie file based on the assigned score for each of the updated item recommendations.

2. The method of claim I wherein the user's response for each of the displayed item recommendations includes user input accepting the item recommendation and user input explicitly rejecting the item recommendation.

3. The method of claim 2, wherein the selecting step comprises:
selecting additional item recommendations for display to the user based on the assigned scores, wherein item recommendations having assigned scores with greater weight are displayed before item recommendations having assigned scores with less weight.

4. The method of claim 2, wherein the item recommendations are suggestions of new social connections for the user in the social networking service, the new social connections corresponding to other users of the social networking service.

5. The method of claim 4, wherein the suggestions of new social connections are based on existing social connections in one or more social graphs associated with the user in the social networking service.

6. The method of claim 5, wherein the calculated score is a conditional probability value representing a relative strength or weakness of each suggestion based on a determined degree of relation of the suggestion to the existing social connections associated with the user.

7. The method of claim 5, wherein the suggestions are updated periodically based on changes made to the existing social connections in the one or more social graphs associated with the user.

8. (canceled)

9. (canceled)

10. (canceled)

11. The method of claim 1, wherein the interface is a web interface provided to the user via a web browser executable at a computing device of the user, and wherein the first cookie file is stored at the user's computing device.

12. A non-transitory machine-readable medium comprising instructions stored therein, which when executed by a processor, causes the processor to perform operations comprising:
providing selected item recommendations for display to a user via an interface of a social networking service;
processing a response of the user including the user's interactions with respect to each of the item recommendations displayed during at least a portion of a predetermined time period of user activity in the social networking service corresponding to an activity session associated with a first cookie file that defines an expiration time, the user's response for each of the displayed item recommendations including user input accepting the item recommendation, user input explicitly rejecting the item recommendation or no user input with respect to the item recommendation;
categorizing, based on the user's interactions, each of the item recommendations displayed for which no input was received from the user during the predetermined time period as implicitly rejected item recommendations;
grouping the implicitly rejected item recommendations into different categories;
storing information related to the implicitly rejected item recommendations, the information identifying each implicitly rejected item recommendation and an amount of time the implicitly rejected item recommendation was displayed to the user during the predetermined time period;
updating the item recommendations for the user based on the processed response of the user with respect to each of the item recommendations displayed during the predetermined time period;
calculating a score for each of the updated item recommendations for the user so as to apply a penalty to the respective scores of each implicitly rejected item recommendation, wherein the penalty is based in proportion on the amount of time the implicitly rejected item recommendation was displayed relative to a duration of the predetermined time period such that, for a same total amount of time the implicitly rejected item recommendation is displayed, the penalty assessed to the implicitly rejected item recommendation increases as the duration of the predetermined time period decreases, and wherein calculating the score for each of the updated item recommendations is based at least in part on the score of one or more other implicitly rejected item recommendations in the same category as the updated item recommendation;
assigning the calculated score to each of the respective item recommendations; and
selecting additional item recommendations for display to the user during a subsequent activity session associated with a second cookie file based on the assigned scores, wherein item recommendations having assigned scores with greater weight are displayed before item recommendations having assigned scores with less weight.

13. The non-transitory machine-readable medium of claim 12, wherein the item recommendations are suggestions of new social connections for the user in the social networking service, the new social connections corresponding to other users of the social networking service.

14. The non-transitory machine-readable medium of claim 13, wherein the suggestions of new social connections are based on existing social connections in the one or more social graphs associated with the user in the social networking service.

15. The non-transitory machine-readable medium of claim 14, wherein the calculated score is a conditional probability value representing a relative strength or weakness of each suggestion based on a determined degree of relation of the suggestion to the existing social connections associated with the user.

16. The non-transitory machine-readable medium of claim 14, wherein the suggestions are updated periodically based on changes made to the existing social connections in the one or more social graphs associated with the user.

17. (canceled)

18. (canceled)

19. (canceled)

20. A system for automatically generating related user suggestions, the system comprising:
one or more processors;
a display; and
a memory device including processor-readable instructions, which when executed by the one or more processors, configure the one or more processors to perform functions to:
provide selected item recommendations for display to a user via an interface of a social networking service;
process a response of the user including the user's interactions with respect to each of the item recommendations displayed via the interface of the social networking service during at least a portion of a predetermined time period of user activity corresponding to an activity session associated with a first cookie file that defines an expiration time, the user's response for each of the displayed item recommendation including user input accepting the item recommendation, user input explicitly rejecting the item recommendation or no user input with respect to the item recommendation;
categorize, based on the user's interactions, each of the item recommendations displayed for which no input was received from the user during the predetermined time period as implicitly rejected item recommendations;
group the implicitly rejected item recommendations into different categories;
store information related to the implicitly rejected item recommendations, the information identifying each implicitly rejected item recommendation and an amount of time the implicitly rejected item recommendation was displayed to the user during the predetermined time period;
update the item recommendations for the user based on the processed response of the user with respect to each of the item recommendations displayed during the predetermined time period;
calculate a score for each of the updated item recommendations for the user so as to apply a penalty to the respective scores of each implicitly rejected item recommendation, wherein the penalty is based in proportion on the amount of time the implicitly rejected item recommendation was displayed relative to a duration of the predetermined time period such that, for a same total amount of time the implicitly rejected item recommendation is displayed, the penalty assessed to the implicitly rejected item recommendation increases as the duration of the predetermined time period decreases, and wherein calculating the score for each of the updated item recommendations is based at least in part on the score of one or more other implicitly rejected item recommendations in the same category as the updated item recommendation;
assign the calculated score to each of the respective item recommendations; and
select additional item recommendations for display to the user during a subsequent activity session associated with a second cookie file based on the assigned scores, wherein item recommendations having relatively higher scores are selected for display before other item recommendations.
